(19) United States
(12) Patent Application Publication
(10) Pub. No.: US 2010/0308541 A1
(43) Pub. Date: Dec. 9, 2010

(54) STRIP-SEALING GATE

(75) Inventors: Lutz Kuemmel, Juechen (DE); Andreas Gramer, Solingen (DE); Holger Behrens, Erkrath (DE); Matthias Kretschmer, Koeln (DE); Ralf-hartmut Sohl, Solingen (DE); Peter De Kock, Oberhausen (DE)

Correspondence Address: KF ROSS PC, 5683 RIVERDALE AVENUE, SUITE 203 BOX 900, BRONX, NY, 10471-0900, US

(73) Assignee: SMS DEMAG AG, Duesseldorf (DE)

(21) Appl. No.: 12/445,949

(22) PCT Filed: Oct. 12, 2007
(86) PCT No.: PCT/EP2007/008891

§ 371 Date: Apr. 17, 2009

(30) Foreign Application Priority Data
Oct. 27, 2006 (DE) 10 2006 051 396.7
Feb. 28, 2007 (DE) 10 2007 009 678.1

(51) Int. Cl. F16J 15/16

(52) U.S. Cl. 277/345

(57) ABSTRACT

The invention relates to a strip sealing gate (1) for sealing a first chamber (2) with a first pressure level (p₁) in relation to a second chamber (3) with a second pressure level (p₂) that differs from the first, a strip (4), in particular a metal strip, passing through both chambers (2, 3). According to the invention, at least two rollers (5, 6) are provided for sealing the chambers (2, 3), said rollers resting in a sealing manner on either side of the strip (4). The aim of the invention is to improve the sealing action. To achieve this, at least some sections of the circumference of at least one of the rollers (5, 6) are covered with a flexible elastic material (7) and said roller or rollers (5, 6) have an inner core (8) that is covered with a jacket consisting of the flexible elastic material (7). A central region (9) of the inner core (8) has a cylindrical contour (10) and the edge regions (11, 12) of the core (8) are flared.

The invention relates to a strip-sealing gate for sealing a first chamber relative to a second chamber, a strip, in particular a metal strip, passing through both chambers, at least two rollers provided to seal the chambers bearing sealingly against the strip on both faces thereof.

In the production and finishing of metal strip, in particular steel strip, it is sometimes necessary to carry out processes under subatmospheric pressure (vacuum process). To this end the strip is guided into a chamber under subatmospheric pressure. In order to operate continuously, strip-sealing gates of the cited type are necessary that seal the strip between the chambers of different pressures. The gates thus serve primarily to allow there to be a pressure differential between two strip treatment zones.

Generic strip-sealing gates are known, for example, from DE 44 18 383 and from DE 199 60 751. They describe how at a gate two seal rollers bear against the strip in order to seal it, namely a first seal roller on the upper face and a second seal roller on the lower face of the strip. In order to improve the seal tightness of the gate, the rollers are cylindrical and are provided on their outer surfaces with jackets of elastic, flexible material. The jacket can bear against the surface of the strip in a sealing manner and thus increase the seal tightness of the gate.

Strip-sealing gates of this type are generally used for products with a width to thickness ratio of substantially more than 1. They can also be used in order to seal chambers relative to one another in which different media are used for treating the strip.

The above-cited solutions do not always work in a completely satisfactory manner. This applies in particular when the width of the strip to be sealed changes in a batch-style operation. Readjustment of the strip-sealing gate to strips of different width is complex and does not always provide a good seal.

The object of the present invention is therefore to further develop a strip-sealing gate of the type described above such that an improvement can be achieved in this respect. The gate should therefore have an improved sealing effect and be suitable for use universally for strips of different width.

The object of the invention is attained in that at least one of the rollers is provided on its outer surface at least in some regions with a flexible, elastic jacket, the at least one roller having an inner core that is provided with a jacket of the flexible, elastic jacket, the inner core having a cylindrical shape in a central region and wherein the core is of enlarged diameter at its ends.

It is herewith possible to substantially improve the sealing capacity of the rollers in the critical region of the strip edges.

The core is preferably made of two parts that can be displaced relative to one another axially. The strip-sealing gate can thus be easily adjusted to strips of different widths.

One of the interacting rollers can have a continuous cylindrical shape with a constant diameter over its entire axial length. The surface of the roller with continuous cylindrical shape can thereby be made of steel. However, the roller can also have a continuous cylindrical shape with a flexible, elastic jacket.

Alternatively and preferably both of the interacting rollers have an inner core with an outer surface flared at the ends.

The two parts of the core that are axially displaceable relative to one another can have a cross-sectional shape

The at least one roller can furthermore be provided with the jacket of flexible, elastic material over its entire axial length. An alternative thereto provides that the at least one roller is provided with jackets of flexible, elastic material only at its axial ends.

For efficient chamber sealing the at least one roller can bear against at least one seal roller that is provided on the same edge of the strip. The seal roller can thereby bear on a further seal roller. At least one of the seal rollers can thereby engage a sealing surface. It is thereby preferable that the sealing surface is concave conforming to the shape of the seal roller in contact with it.

A seal can be provided in the axial end region of the at least one roller, which seal is in contact with the end face of the at least one roller. The seal can thereby be mounted such that it bears against the end face of the at least one roller and is prestressed elastically axially by a spring.

Furthermore a seal can be provided at the axial end region of the at least one roller, which seal is held at a defined gap spacing to the strip edge via a lateral guide roller engaging the strip edge. Wear of the seal can be substantially reduced hereby.

In order to build up higher pressure differentials, it has proven useful if several gate stages are cascaded one after the other in the strip travel direction.

The strip-sealing gate is preferably used to seal a first chamber with a first pressure level relative to a second chamber with a second pressure level different from the first pressure level. However, it can also be used when the chambers have the same pressure when different media have to be sealed relative to one another therein; in this case the strip-sealing gate is used to seal a first chamber with a first process medium relative to a second chamber with a second process medium differing from the first process medium.

The drawing shows embodiments of the invention. Therein:

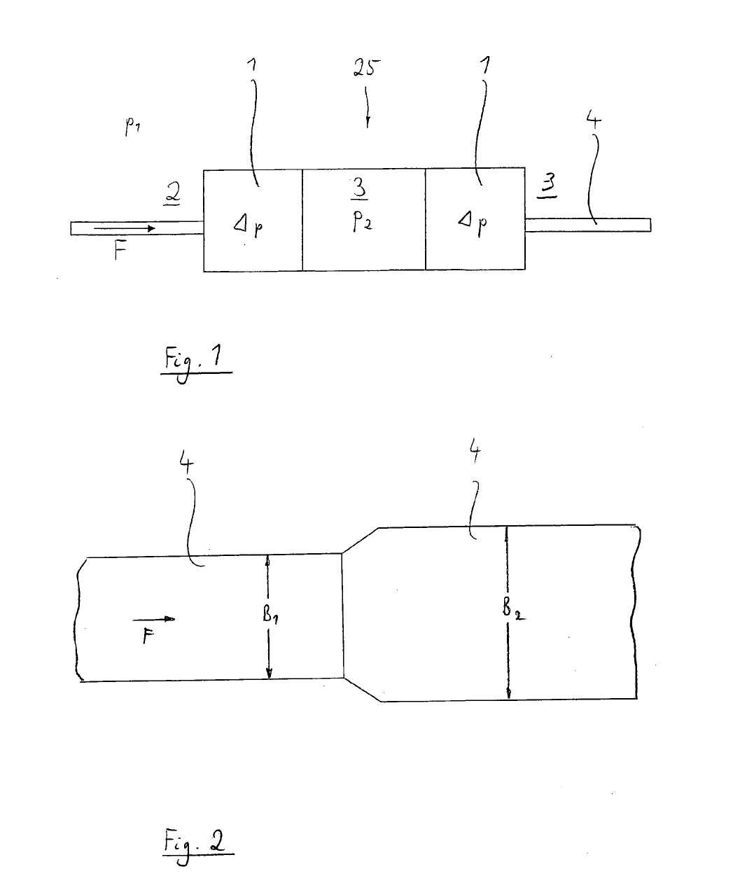

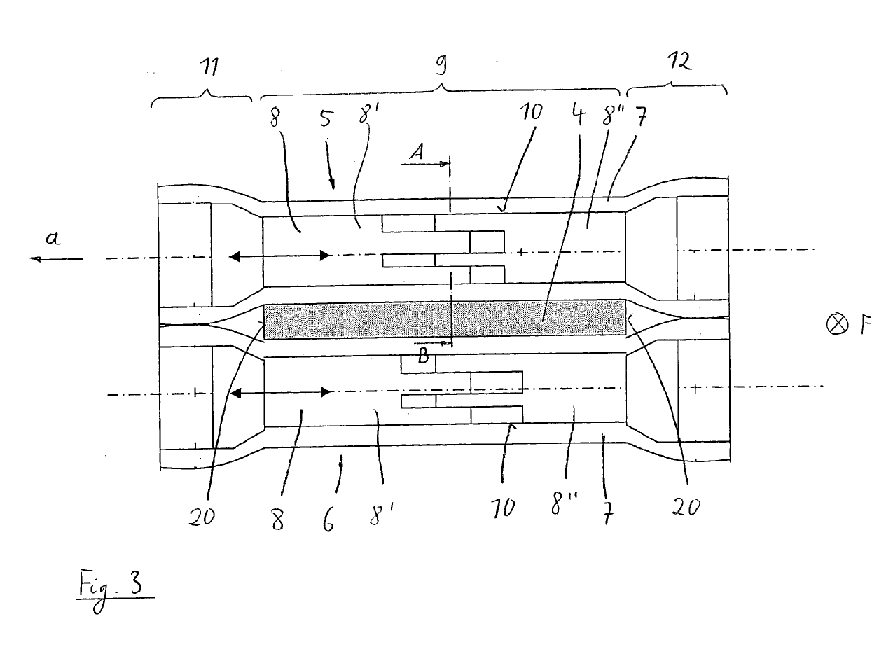

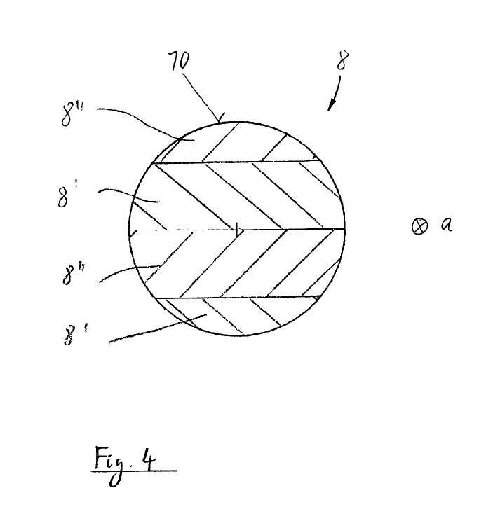

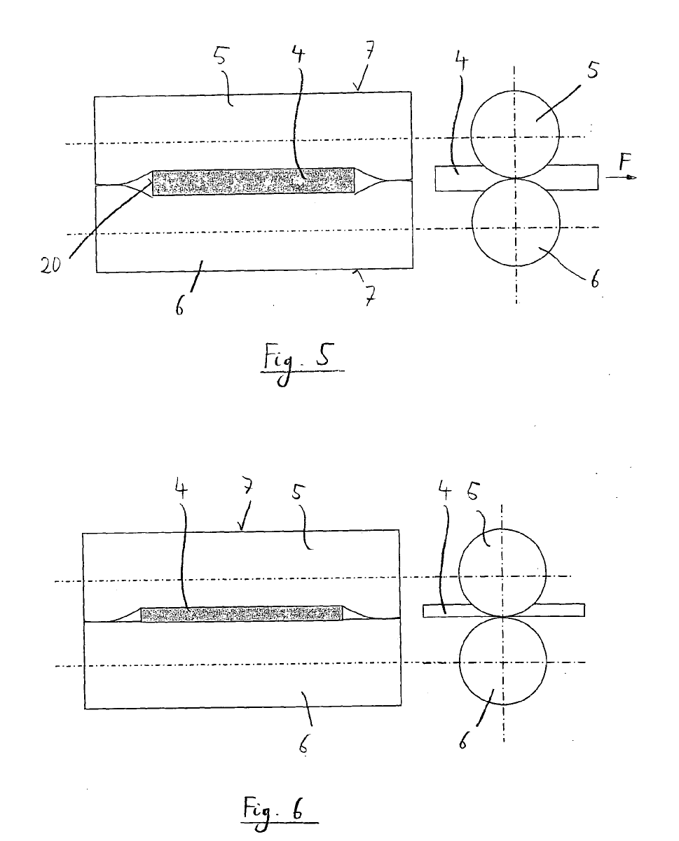

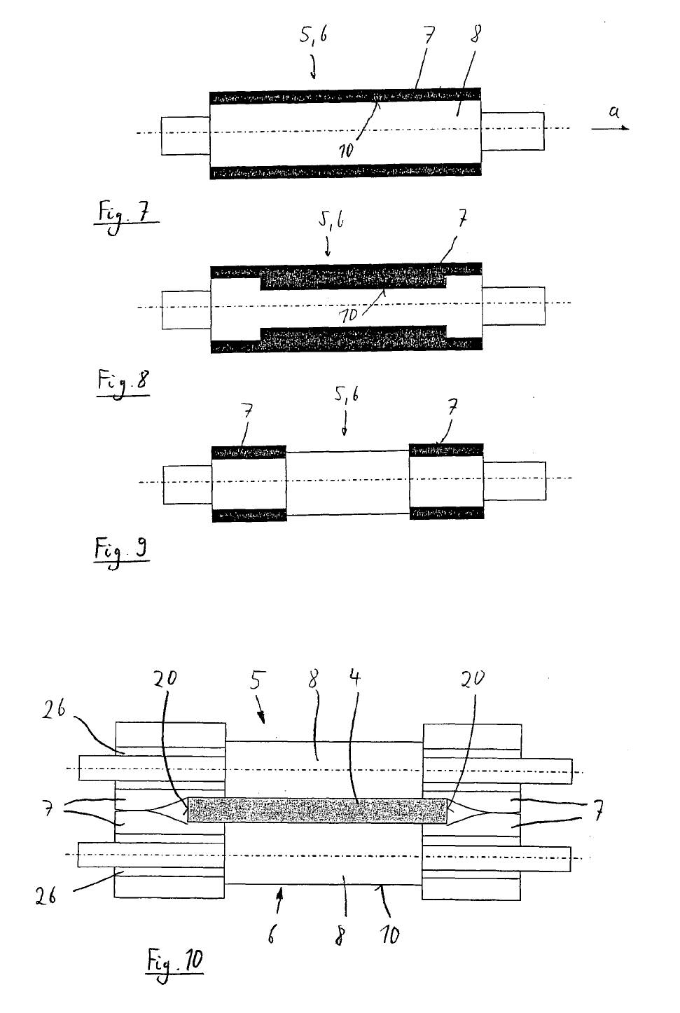

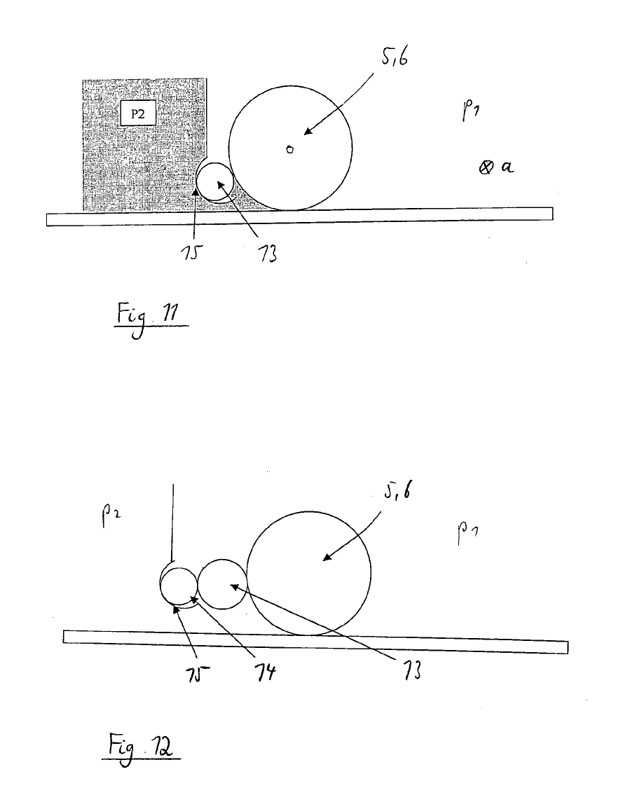

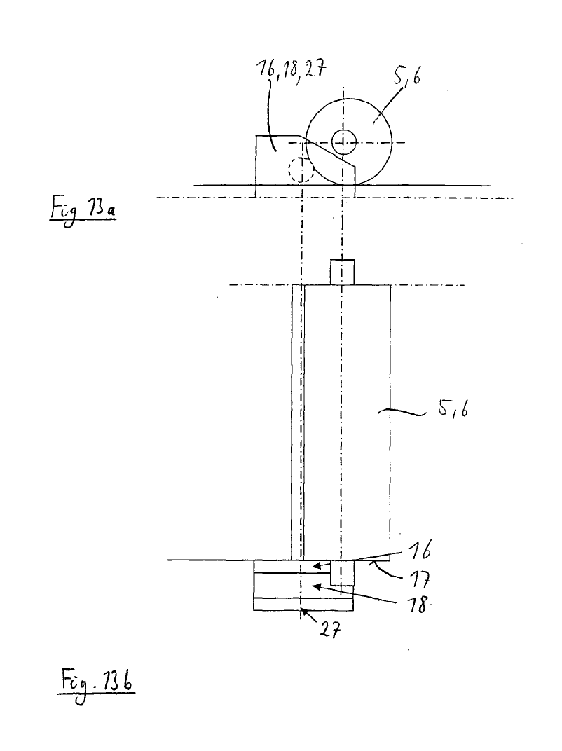

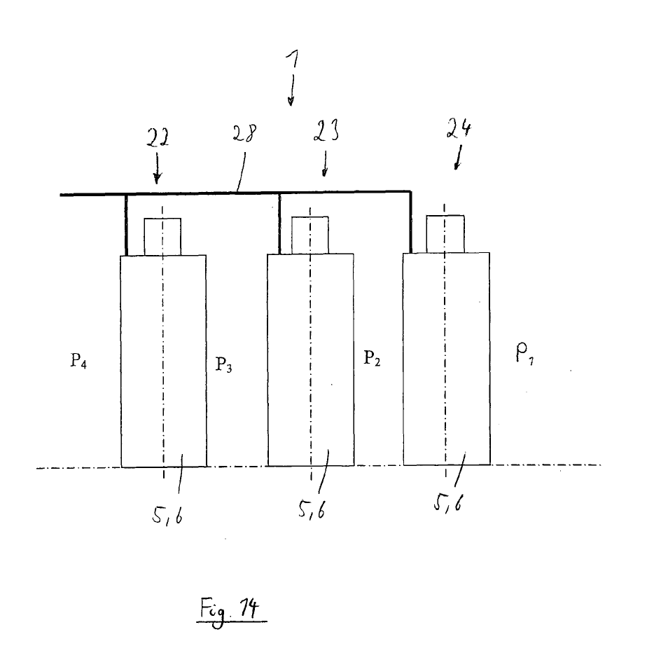

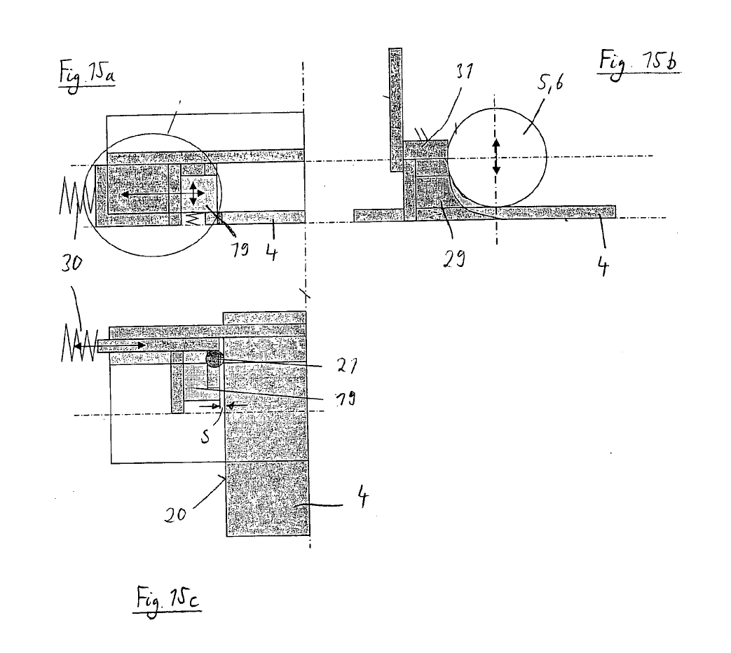

FIG. 1 is a diagrammatic side view of a process zone for treating a steel strip with strip-sealing gates,

FIG. 2 is a plan view of a strip that can pass through the process zone as in FIG. 1 sealed by strip-sealing gates,

FIG. 3 shows two interacting rollers for sealing the strip, seen in the travel direction of the strip,

FIG. 4 is a section along line A-B of FIG. 3 through a seal roller, shown without its jacket of elastic material,

FIG. 5 is a view in the travel direction and axially of an embodiment of two seal rollers that bear against a strip,

FIG. 6 is an alternative embodiment of two seal rollers shown as in FIG. 5,

FIG. 7 is a diagrammatic view of a first embodiment of a roller together with its elastic jacket,

FIG. 8 is a diagrammatic view of a second embodiment of a roller together with its elastic jacket,

FIG. 9 is a diagrammatic view of a third embodiment of a roller together with its elastic jacket,

FIG. 10 is a view of a roller as in FIG. 9 of a roller together with elastic jacket with some details,

FIG. 11 is an axial view of a roller above the strip to be sealed with a seal roller provided behind it,

FIG. 12 in an axial view of an embodiment of the roller alternative to FIG. 11 with two seal rollers arranged behind it,

FIG. 13a is an axial view of a roller together with arrangement for the side sealing of the same, seen axially, and

FIG. 13b the plan view associated with FIG. 13a,

FIG. 14 diagrammatically the representation of a strip-sealing gate with several gate stages,

FIG. 15a an arrangement for the side sealing of the strip seen in the travel direction of the strip,

FIG. 15b the arrangement for side sealing according to FIG. 15a seen axially of the roller and

FIG. 15c the plan view of the arrangement for side sealing according to FIG. 15a.

FIG. 1 shows a process zone 25 through which a strip 4 is conveyed continuously in the travel direction F. A second pressure p₂ acts in the process zone 25, which second pressure is reduced relative to ambient pressure p_{1.} (first pressure). In order to also maintain the pressure differential Δp between the two pressures in continuous operation, one strip-sealing gate 1 is located in the travel direction F in front of and one behind the process zone 25. The environment therefore forms a first chamber 2 and the process zone 25 forms a second chamber 3 in which different pressures prevail. To produce the seal, each strip-sealing gate 1 has at least two rollers that are explained in more detail below.

The strip 4 must be guided as continuously as possible through the treatment installation. To this end strip coils are connected to one anther by welding the leading end of one strip to the trailing end of the preceding strip. The width and/or the thickness of the strip 4 can thereby change more or less constantly at the joint, as can be seen in FIG. 2. In the illustrated embodiment according to FIG. 2, the strip 4 at the front in travel direction F has a larger width B₂ than the following strip 4, which has a width B₁. As is shown, an edge chamfer can render possible a smooth transition.

In order to make rollers for sealing the strip 4 suitable in an improved manner for products with variable thickness and/or width, an embodiment of the rollers is provided as shown in FIG. 3.

The strip 4 is first of all shown here, namely seen in the travel direction F. For sealing a roller 5 bears against the upper face of the strip 4 and a roller 6 bears against the lower face of the strip 4. Each roller 5 and 6 has a core 8 of steel that is surrounded by a jacket 7 of flexible, elastic material. While the core 8 has a cylindrical outer surface 10 in a central region 9, it flares radially at its ends 11 and 12, with a cylindrical surface provided outside the conical part.

The radially flared ends of the core 8 and thus also of the jacket 7, produce an improved sealing effect at the ends of the rollers 5 and 6.

To ensure that this can also be optimally used with strips 4 of different width, the core 8 is made of two parts 8′ and 8″ that are axially displaceable relative to one another. The two parts 8′, 8″ are thereby formed at their overlapping inner ends such that they have a complementary shape in cross section, as shown in FIG. 4.

With this embodiment it is possible to draw apart the rollers 5 and 6 or to push them together parallel to the axis a with actuating means (not shown) in order to adapt the axial length of the cylindrical regions 10 of the core 8 to the actual strip width. This way an optimal sealing effect is achieved through the rollers 5 and 6 with strips of different width.

The cores 8 are thus covered with the jacket of flexible jacket 7 so they are radially expansible. Adjustment to the width of the strip 4 is carried out by pushing into one another or drawing apart the core 8 in the direction of the axis a. The strip thickness adjustment is carried out by control devices (e.g. spreadable mandrels) below the elastic jacket 7.

FIG. 5 again shows the principle of the arrangement according to FIG. 3, i.e. the two rollers 5 and 6 that each have a jacket of elastic jacket 7 and bear against the strip 4 such that it is optimally sealed. A triangular area remains open only at an edge 20 of the strip, which triangle is smaller as the jacket 7 is more elastic.

The strip 4 is thus embedded in the elastic jacket 7. The regions at the edges of the strip are sealed by the direct contact of the roller jackets. The flexibility of the jacket 7 makes it possible to seal different strip thicknesses in the typical operating range without readjustment of the rollers.

However, it is also possible that only one roller 5 is formed in this manner and interacts with another roller 6 that, for example, has a steel jacket that has no elasticity on its outer surface. This can be seen in FIG. 6. The attachment of the elastic jacket 7 results here as shown.

FIGS. 7, 8 and 9 diagrammatically illustrate different embodiments of the rollers 5 and 6.

In FIG. 7 the elastic jacket 7 has a constant thickness over the entire length of the roller 5 and 6 in the direction of axis a; the cylindrical surface 10 of the roller 5 and 6 indicated here is of constant diameter over the entire roller width.

According to the solution according to FIG. 8, the cylindrical surface 10 of the core 8 in the central region of the roller 5 and 6 is reduced in diameter to accommodate an elastic jacket 7 that is thicker here.

With the solution according to FIG. 9 the elastic jacket 7 is provided only at the ends of the roller 5 and 6, since ultimately this is where the critical part of the seal lies (in the region of the strip edge).

The solution according to FIG. 9 is shown again in more detail in FIG. 10. It can be seen here that the jackets 7 of elastic material are supported on the cores 8 via sleeves 26. The cylindrical central region 10 is made shorter than the minimal strip width. The jackets 7 of elastic material always cover the strip edge 20. The jackets 7 of flexible material are simple to replace because of the sleeves 26.

FIG. 11 shows how a rear chamber sealing of the strip-sealing gate 1 can be achieved. The roller 5 or 6 here bears against a seal roller 13 that extends the full length in the direction of the axis a of the roller 5 and 6. The seal roller 13 in turn bears on a sealing surface 15 that, according to the shape of the seal roller 13, has a concave engagement face. This engagement face forms a slide surface or a friction bearing.

A fixed seal roller 13 is thus pressed against the roller 5 or 6 sealing the process chamber. This seal roller forms in combination with the supporting slide surface 15 the seal in the rear chamber area. This seal also works with the use of the flexible jacket 7; the seal roller 13 is accordingly pressed into the jacket 7 of elastic material.

FIG. 12 shows that this principle can also be used when two seal rollers 13 and 14 are used. The seal roller 13 can be embodied here as a flexible seal roller. It is sealed by a fixed seal roller 14 on its rear side. The seal roller 14 forms in combination with the supporting slide surface 15 the seal in the rear chamber area.

The side seal can be taken care of by clamping pads or sealing plates, as shown in FIGS. 13a and 13b.

The side seal is formed by a flexible seal 16 that is embodied formed as a plate. The seal 16 seals an end face 17 of the roller 5 and 6. For a better sealing effect, a spring 18 acts between a fixed counter plate 27 and the seal 16, which spring presses the seal 16 in the direction of the axis a against the end face 17 of the roller 5 and 6. The spring 18 can be, for example, a brush or plastic foam.

In the case of the seal of the rear chamber with seal rollers, if necessary the journals or clamping pads for the axial support of the seal rollers formed by the side sealing region. Alternatively a fixed clamping pad can be placed in the seal roller region from outside onto the seal 16.

The axial support prevents lifting of the seal 16 in the case of axial forces occurring on the seal roller and the associated leakage.

FIG. 14 shows that several gate stages 22, 23, 24 can be provided in order to build up respective pressure differentials inside a chamber wall 28 and thus gradually build up or reduce the pressure along the strip-sealing gate 1.

The pressure rises or falls gradually from pressure p₁ via pressure p₂ and pressure p₃ to pressure p₄. A cascade buildup is therefore selected here, in order to build up or reduce the pressure from gate stage to gate stage. This means that the maximum pressure differential to be sealed in the roller region always relates only to the pressure differential to be sealed in the process zone of the current gate stage.

The consequence is a reduction of the leakage volume to be pumped out.

FIGS. 15a, 15b and 15c finally show a further sealing system for a strip-sealing gate, which is suitable above all for strips with variable thickness and width.

The seal in the region of the strip edge 20 is carried out via the device shown. To adjust the device to the current strip width, a prepositioning of the side seal 19 is carried out. A further seal 29 is provided for the rear chamber seal.

The adjustment to small changes of the strip width or the strip position is carried out by a spring 30. In order to protect the seal 19 against wear, a guide roller 21 is provided that rolls on the strip edge 20, the roller maintaining a small gap s of the seal 19 to the strip edge 20.

The sealing at the strip edge is thus achieved via a multi-part sealing system. The spring-loaded and displaceable seal 19 (sliding block) adjusts automatically to the existing roller position. The seal of the roller 5 and 6 is carried out in the rear chamber area through a sealing strip 31 in frictional contact.

With the proposed solution chambers of different pressure as well as chambers of the same pressure can be sealed relative to one another, in which different process media, in particular process gases, as well as liquids are located. If lateral rollers are provided that engage the strip ends, a very good lateral guiding of the strip can be achieved. Rollers running on the surface of the strip can be used to guide cover elements.

### LIST OF REFERENCE NUMBERS

1 Strip-sealing gate
2 First chamber
3 Second chamber
4 Strip
5 Roller
6 Roller
7 Flexible, elastic jacket
8 Inner core
8′ Part of the core
8″ Part of the core
9 Central region
10 Cylindrical surface
11 End
12 End
13 Seal roller
14 Seal roller
15 Sealing surface
16 Seal
17 End face of the roller
18 Spring
19 Seal
20 Strip edge
21 Guide roller
22 Gate stage
23 Gate stage
24 Gate stage
25 Process zone
26 Sleeve
27 Counter plate
28 Chamber limit
29 Seal
30 Spring
31 Sealing strip
p₁ First pressure level
p₂ Second pressure level
p₃ Further pressure level
p₄ Further pressure level
Δp Pressure differential
F Travel direction
A Axial direction
S Gap spacing
B₁ Strip width
B₂ Strip width

1. A strip-sealing gate for sealing a first chamber relative to a second chamber, metal strip, passing through both chambers, the gate comprising:
at least two rollers provided to seal the chambers, extending along respective axes, and bearing sealingly against the strip on both faces thereof;
a flexible elastic jacket on at least one of the rollers on its outer surface at least in some regions, the at least one roller having an inner core that is provided with the jacket of the flexible, elastic material, that has a cylindrical central surface in a central region and that is flared at its ends so that the respective roller is radially flared at its ends relative to the central region.

2. The strip-sealing gate according to claim 1 wherein the core is made of two parts that can be displaced relative to one another in the direction of the respective axis.

3. The strip-sealing gate according to claim 1 wherein the other of the rollers has a continuous cylindrical shape with constant diameter over its entire axial length.

4. The strip-sealing gate according to claim 3 wherein the surface of the roller with continuous cylindrical shape is made of steel.

5. The strip-sealing gate according to claim 3 wherein the roller provided with a continuous cylindrical shape is provided with flexible, elastic jacket.

6. The strip-sealing gate according to claim 1 wherein both of the rollers have such an inner core with an outer surface flared at the ends.

7. The strip-sealing gate according to claim 2 wherein the two parts that are axially displaceable relative to one another have a cross-sectional shape complementary to one another in a central contact area.

8. The strip-sealing gate according to claim 1 wherein the at least one roller is provided with the jacket of flexible, elastic material over its entire axial length.

9. The strip-sealing gate according to claim 1 wherein the at least one roller is provided with the jacket of flexible, elastic material only at its axial ends.

10. The strip-sealing gate according to claim 1 wherein the at least one roller engages at least one seal roller that is provided on the same strip edge.

11. The strip-sealing gate according to claim 10 wherein the seal roller engages a further seal roller.

12. The strip-sealing gate according to claim 10 wherein at least one of the seal rollers engages a sealing surface.

13. The strip-sealing gate according to claim 12 wherein the sealing surface is concave and conforms to the shape of the seal roller in contact with it.

14. The strip-sealing gate according to claim 1, further comprising:
a seal in the axial end region of the at least one roller and in contact with the end face of the at least one roller.

15. The strip-sealing gate according to claim 14 wherein the seal bears against an end face of the at least one roller and is prestressed elastically in the direction of the axis by a spring.

16. The strip-sealing gate according to claim 1, further comprising:
a seal in the axial end region of the at least one roller, and
means including a guide roller engaging the strip edge for holding the seal at a defined gap spacing from the strip edge.

17. The strip-sealing gate according to claim 1 wherein several such gates are provided in stages one behind the other in a strip travel direction.

18. The strip-sealing gate according to claim 1 wherein the gate is used to seal a first chamber with a first pressure level relative to a second chamber with a second pressure level deviating from the first pressure level.

19. The strip-sealing gate according to claim 1 wherein the gate is used to seal a first chamber with a first process medium relative to a second chamber with a second process medium differing from the first process medium.
